(19) United States
(12) Patent Application Publication
(10) Pub. No.: US 2022/0278596 A1
(43) Pub. Date: Sep. 1, 2022

(54) Twisting Device and Method for a Hairpin Winding

(71) Applicant: ZF FRIEDRICHSHAFEN AG, Friedrichshafen (DE)

(72) Inventors: Matthias EBERT, Himmelstadt (DE); Bernhard BYZIO, Bad Kissingen (DE); Jürgen TRÖSTER, Dittelbrunn (DE); Michael WEIGEL, Schweinfurt (DE)

(21) Appl. No.: 17/632,787

(22) PCT Filed: Jul. 24, 2020
(86) PCT No.: PCT/EP2020/070924

§ 371 Date: Feb. 3, 2022

(30) Foreign Application Priority Data
Aug. 5, 2019 (DE) 10 2019 211 713.9

(51) Int. Cl. H02K 15/00

(52) U.S. Cl. CPC H02K 15/0087

(57) ABSTRACT

A device for twisting hairpin ends of a coil formed from hairpins for an electric machine includes: a plurality of coaxially arranged twisting rings having: two outer twisting rings and, therebetween, at least at least two inner twisting rings. The twisting rings have, in each instance, at an axial end facing hairpin ends, a plurality of pockets distributed over a circumference for receiving a hairpin end, respectively. The twisting rings are twistable in opposite directions relative to one another, the twisting rings having couplings by which twisting rings with like rotational direction are connectable.

### CROSS REFERENCE TO RELATED APPLICATIONS

This is a U.S. national stage of International application No. PCT/EP2020/070924, filed on Jul. 24, 2020, which claims priority to German Application No. 10 2019 211 713.9 filed Aug. 5, 2019, the content of each of which is incorporated herein by reference.

### BACKGROUND OF THE INVENTION

### 1. Field of the Invention

The present invention is directed to a device and a method for twisting during the production of a coil from hairpins in which the individual hairpin ends axially projecting from the coil body are shaped and interconnected by a determined amount in circumferential direction to allow an electrical contact-connection to further hairpin ends.

### 2. Description of the Related Art

It is known in the prior art for the hairpin ends that are arranged in layers to be shaped individually or by individual layers. Further, it is known from US 2009-302705 A to individually drive a plurality of coaxial rings. The rings have eroded recesses for the hairpin ends. Problems in the prior art consist, inter alia, in the complicated construction of the device and in the individual parts of this device which are uneconomical to produce.

### SUMMARY OF THE INVENTION

It is an object of the present invention to provide a simpler device.

This object is met by a device and method according to the independent claims.

According to an aspect of the invention, a device for twisting hairpin ends of a coil formed from hairpins for an electric machine is provided, the device comprising a plurality of coaxially arranged twisting rings, wherein two outer twisting rings and, therebetween, at least two inner twisting rings, are arranged, wherein the twisting rings have, in each instance, at an axial end facing the hairpin ends, a plurality of pockets distributed over the circumference for receiving a hairpin end, respectively, and wherein the twisting rings are twistable in opposite directions relative to one another. The device is characterized in that the twisting rings have couplings by which twisting rings with like rotational direction are connectable.

A hairpin winding is formed from a plurality of hairpins or shaped bars which have contact points at their ends on the end winding. At least two hairpins are electrically conductively connected to one another at the contact points in each instance in order to produce the coils of the hairpin winding from the hairpins. The contact points to be connected to one another are designated as hairpin ends, and the respective individual contact points at the start and end of the respective coils are designated as connection pins. For controlling the electric machine, the connection pins are electrically conductively connected to an interconnect.

Depending on the configuration and output of the electric machine, hairpin windings are generally formed with at least four, often six or eight, or possibly more layers of hairpins per slot. The device has at least a quantity of twisting rings corresponding to the quantity of layers, these twisting rings being formed in a sleeve-shaped manner and arranged to be coaxially nested one inside the other. At one axial end that faces the hairpin ends, the twisting rings have pockets for receiving a hairpin end in each instance.

A small gap is provided in each instance between the twisting rings to allow a relative movement of the twisting rings with respect to one another, this gap being smaller, preferably smaller than one half of the width of a hairpin end in radial direction, in order to prevent the hairpin ends from entering the gap. The gap is formed as small as possible in order to prevent the hairpin end from entering or to prevent a deformation of the hairpin end.

The inner twisting rings have a width in a radial direction which corresponds at least to the width of a hairpin end in radial direction in order to allow sufficiently large pockets for receiving the hairpin ends. The maximum width of the inner twisting rings is preferably smaller than three times the width of a hairpin end, particularly smaller than twice the width of a hairpin end.

The outer twisting rings can be constructed more solidly because they are adjacent to another twisting ring only on one side. The device is advantageously connected to a drive or receiving elements of a machine tool, respectively, via the outer twisting rings.

The straight hairpins or shaped bars inserted into the slots project over the stator by their ends. In order to achieve a distributed coil winding, the hairpin ends must be bent in circumferential direction so that contact points of different hairpins which are to be connected can be arranged adjacent to one another and subsequently electrically conductively connected to one another. The twisting rings of the device are formed to be twistable relative to one another for this purpose.

Further, the device has couplings by which twisting rings that are rotated in like direction are connectable to one another and jointly moveable. Because of the couplings, the quantity of drives can be kept small and devices can be used for different coils possibly on the same installation.

Embodiment forms of a device are characterized in that directly adjacent twisting rings are twistable in opposite directions. In particular, directly adjacent twisting rings are twistable in opposite directions to achieve a uniform deformation of the hairpin ends. In this way, the hairpins can be connected to form a coil with a conductor extending in an undulating manner.

Devices according to embodiment forms are characterized in that at least the inner twisting rings have a passage for the couplings of the twisting rings with a different rotational direction. At least one passage is provided in the twisting rings for the couplings of a different rotational direction so that the couplings can produce a connection between twisting rings with like rotational direction without impeding twisting rings with no rotational direction or an opposite rotational direction which may possibly be located therebetween.

Preferred embodiment forms of an aforementioned device are characterized in that the passage is formed as an elongated hole extending over a portion of the circumference. A passage can be provided for the couplings in a simple manner by means of an elongated hole extending over a portion of the circumference. The elongated hole preferably extends at least over an angular area of the circumference corresponding to the sum of the rotational angles in both rotational directions. In an initial position, the couplings are preferably located at one end of the elongated hole in circumferential direction. In further preferred embodiment forms, this end of the elongated hole can advantageously serve as a stop so that the device can be restored again to a defined initial position in a simple manner.

Devices according to embodiment forms are characterized in that the twisting rings have, in each instance, at least two couplings which are distributed, preferably symmetrically, over the circumference. In order to achieve a uniform distribution of the driving force and to reduce the risk of a tilting of the twisting rings relative to one another, a plurality of couplings are arranged, respectively, to be distributed along the circumference. This also reduces the force to be transmitted per each of the couplings. The at least two couplings are preferably symmetrically distributed over the circumference, which ensures a more uniform distribution of force. For example, two coupling units can be provided diametrically opposed to one another per rotational direction. In larger devices, it is also possible to arrange three couplings offset, for example, by 120°, four couplings offset by 90°, or more couplings. If couplings are provided for different rotational directions they are preferably arranged to alternate in circumferential direction.

Embodiment forms of a device are characterized in that the couplings are each formed as an alignment pin received in corresponding receptacles at the twisting rings. For a rigid connection between the twisting rings, couplings such as an alignment pin or screws are advantageous because they are readily available and easy to assemble. Alignment pins in particular have the further advantage that a defined contact area is provided over the standardized lateral surface of the alignment pins.

Preferred embodiment forms of a device are characterized in that some of the twisting rings have receptacles which, in movement direction, have a clearance relative to the alignment pin in the initial position in order to move the twisting ring by a rotational angle that is smaller than the alignment pin by an amount corresponding to the clearance. Instead of a fixed connection in circumferential direction of the twisting rings with like rotational direction, some of the receptacles for the couplings, particularly alignment pins, can also have a clearance in movement direction so as to minimize the twisting ring being carried along by an angle corresponding to the clearance. Different twisting angles for the individual twisting rings can be achieved in that the corresponding twisting ring is carried along in retarded manner due to the clearance because the couplings come in contact with the receptacle only after a determined angular area has already been covered in circumferential direction. Different twisting angles of the various layers may be advantageous with respect to the geometric arrangement of the hairpin ends and the arrangement of the latter relative to one another.

Devices according to embodiment forms are characterized in that the quantity of twisting rings corresponds to the quantity of layers of the coil. In order to twist all of the layers of a coil with hairpin winding simultaneously or in one work step, at least a quantity of twisting rings corresponding to the layers is advantageously provided.

Embodiment forms of a device are characterized in that the quantity of pockets per twisting ring corresponds to the quantity of slots of the coil. In order to shape all of the hairpin ends of a layer simultaneously in a twisting ring, a quantity of pockets corresponding to the quantity of slots is advantageously provided at an axial end of the respective twisting ring.

Embodiment forms of a device are characterized in that the pockets are formed to be open on one side in radial direction, the pockets of the outer twisting rings being formed in each instance to open in direction of the further twisting rings, and in that the pockets of the inner twisting rings are formed in each instance to open toward the open side of the pockets of a directly adjacent twisting ring. The pockets provided in the twisting rings are open along a circumferential area of the twisting ring. In this way, the width of the twisting rings, particularly of the inner twisting rings, can be kept small so that the hairpin ends which are not shaped can be received more easily in the pockets after insertion into the coil. A further advantage of the pockets which are open radially on one side consists in that, during the twisting movement in which the hairpin ends are shaped in circumferential direction, the hairpin ends also undergo a force effect in radial direction. Due to the force effect in radial direction, the hairpin ends either contact the radial circumferential wall of the pocket and are accordingly held completely in the layer or slide on the open side along the circumferential area of the adjacent twisting ring, and the hairpin ends therefore move closer to the hairpin ends of this adjacent layer to which they are electrically conductively connected in a subsequent work step.

Devices according to embodiment forms are characterized in that the pockets have at least a depth in axial direction corresponding to an uninsulated length of the hairpin ends. For subsequent connection, the hairpin ends preferably have end regions which are not insulated or from which insulation has been removed. In order to retain an orientation of the uninsulated end regions which is as axial as possible, these end regions are advantageously received in the pockets. A transmission of force during the twisting movement is also improved as a result of pockets which are formed with a corresponding depth in axial direction. The pockets can also have a depth such that insulated areas are also received. Pockets with a different axial depth can also advantageously be provided to accommodate hairpin ends or, particularly, connection pins which may possibly vary in length.

Embodiment forms of a device are characterized in that the outer twisting rings have a fastener or fasteners by which the device is connectable to drives for the rotational movements. In order to move the twisting rings in circumferential direction, a connection to one or more drives is necessary. Preferably, one drive per rotational direction is provided, these drives being connected, particularly detachably, to the device via the fasteners. Devices can be used on one machine for variously dimensioned coils in that the connection points of the drives are suitably formed, for example, as rotary disks to which a twisting ring is applied by the fastener or fasteners such as screws or as revolving levers or ring segments to which a twisting ring is connected. Instead of twisting rings with which the couplings are fixedly connected, the couplings can also be directly connected to the drives.

A further aspect of the invention is a method for twisting hairpin ends of a coil for an electric machine by a device according to the description and figures comprising the following method steps: fitting the device on the hairpin ends, at least the uninsulated hairpin ends being received in pockets of the twisting rings; rotating the twisting rings in opposite directions, twisting rings which are connected to one another via couplings being rotated in the same direction; removing the coil with shaped hairpin ends from the device.

As is also stated in the description of the device, the end regions of the hairpins, preferably the uninsulated end regions, are received in the pockets of the twisting rings. Subsequently, the twisting rings are twisted relative to one another, twisting rings with a like rotational direction being connected via couplings. The connection via the couplings can be rigid so that all of the connected twisting rings are moved by the same rotational angle. Alternatively, the couplings can also be formed such that the twisting rings are moved by different rotational angles in that the couplings are formed, for example, by gears or the like or, by corresponding receptacles on the twisting rings, enter into operative connection with the couplings only subsequently. Different twisting angles can be provided for the different layers by different rotational angles.

Relative rotational movements of the twisting rings in opposite rotational directions can be carried out simultaneously or also sequentially.

After the twisting process, the coil is removed from the device, the end regions of the hairpins, which are now shaped, being pulled out of the pockets of the twisting rings in axial direction. The coil is subsequently conveyed to further production steps, for example, a welding of the shaped hairpin ends.

After the coil has been removed, the twisting rings are preferably rotated back into their initial position again before the next coil is inserted.

An aspect of the invention is also an electric machine with a coil which is formed from hairpins and which is produced by a described method on a device according to the description. The machine has at least one drive to which the fasteners of the device are connectable.

### BRIEF DESCRIPTION OF THE DRAWINGS

The invention will be explained in more detail in the following with reference to the figures. Like or similar component parts are designated by consistent reference numerals.

In the figures:

FIG. 1 is an exemplary embodiment of a device;

FIG. 2 is a further exemplary embodiment of a device;

FIG. 3 is a section in radial direction of an exemplary embodiment according to FIG. 2;

and

FIG. 4 is a portion of a further exemplary embodiment of a device in axial section.

### DETAILED DESCRIPTION OF THE PRESENTLY PREFERRED EMBODIMENTS

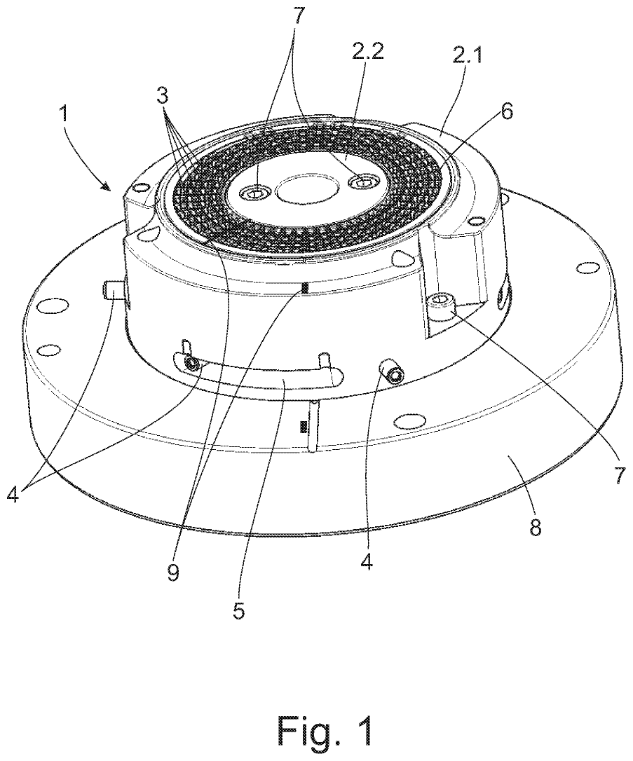

FIG. 1 shows an exemplary embodiment of a device 1. The device 1 comprises a plurality of twisting rings 2.1; 2.2; 3 which are coaxially arranged. Accordingly, a plurality of inner twisting rings 3 is located between the two outer twisting rings 2.1; 2.2. The outer twisting rings 2.1; 2.2 can be constructed more solidly. The radially inner outer twisting ring 2.2 can also be formed as a solid cylinder. The outer twisting rings 2.1; 2.2 are connected in each instance to a separate drive 8 via fasteners 7 in order to move the twisting rings 2.1; 2.2 opposite one another in circumferential direction. Only one carrier plate is shown in FIG. 1 for a drive 8 and is connected to the radially outer outer twisting ring 2.1.

The twisting rings 2.1; 2.2; 3 with like rotational direction are connected to one another in each instance via couplings 4; 4.1; 4.2. A drive force is transmitted from a driven twisting ring 2.1; 2.2; 3, preferably an outer twisting ring 2.1; 2.2, to the further twisting rings 2.1; 2.2; 3, preferably inner twisting rings 3, with like rotational direction by means of the couplings 4; 4.1; 4.2.

In order to prevent the couplings 4; 4.1; 4.2 from being blocked by twisting rings 2.1; 2.2; 3 located between or adjacent to the connected twisting rings 2.1; 2.2; 3, these twisting rings 2.1; 2.2; 3 have, in each instance, passages 5; 5.1; 5.2 for the couplings 4; 4.1; 4.2 of the other respective rotational direction. In FIG. 1, passages 5; 5.2 are also provided in the radially outer outer twisting ring 2.1. These passages 5; 5.1; 5.2 facilitate the guidance of the couplings 4; 4.1; 4.2, particularly in axial direction, and provide a better transmission of force to the adjacent twisting ring 3 connected to couplings 4; 4.1; 4.2. Correspondingly, passages 5; 5.1 can also be similarly provided at the radially inner outer twisting ring 2.2. Instead of continuous cutouts in the outer twisting rings 2.1; 2.2, the passages 5; 5.1; 5.2 can also be formed by slots. Embodiment forms are also possible in which no passages 5; 5.1; 5.2 are provided in the outer twisting rings 2.1; 2.2, which lowers production expenditure.

In embodiment forms, the couplings 4; 4.1; 4.2 can also be connected to the respective drive instead of the twisting rings 2.1; 2.2; 3. This is particularly advantageous in embodiment forms in which the outer twisting rings 2.1; 2.2 have a like rotational direction.

Pockets 6; 6.1; 6.2 which serve to receive hairpin ends of a coil which is held at least in circumferential direction are provided in each instance at an axial end of the individual twisting rings 2.1; 2.2; 3. The hairpin ends are moved in circumferential direction and accordingly shaped when the twisting rings 2.1; 2.2; 3 are twisted. The coil is preferably merely guided in axial direction so that a change in the axial length due to the deformation of the hairpin ends in circumferential direction can be compensated or adjusted.

FIG. 1 additionally shows optional positioning indicators 9 with which, for example, an initial position of the device can be marked. The positioning indicators 9 are provided as radial markings on two adjacent twisting rings 2.1; 2.2; 3. Accordingly, a correct positioning or orientation of the device 1, more precisely of the twisting rings 2.1; 2.2; 3, relative to one another can be checked and ensured.

Embodiment forms are also possible in which the outer twisting rings 2.1; 2.2 have no pockets 6; 6.1; 6.2 or have pockets 6; 6.1; 6.2 which are not utilized and the outer twisting rings 2.1; 2.2 are connected to the drives and only actuate the couplings 4 and hold the inner twisting rings 3. In this way, the same outer twisting rings 2.1; 2.2 can be used for different implementations with different inner twisting rings 3 in order to lower tool costs for each implementation.

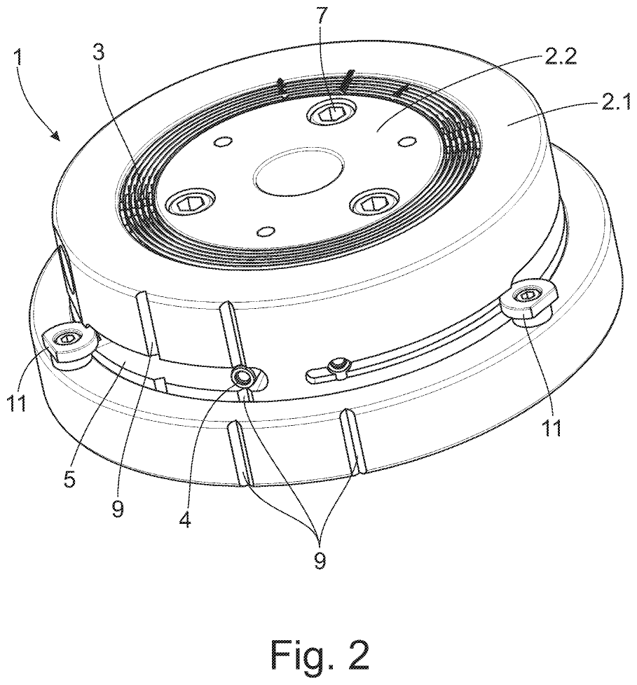

FIG. 2 shows a further embodiment form of a device 1. The basic construction substantially corresponds to that of the construction described above referring to FIG. 1, and reference is made to this figure.

One difference compared to the exemplary embodiment in FIG. 1 consists in that the outside outer twisting ring 2.1 and the inner twisting rings 3 lie on a portion of the inside outer twisting ring 2.2 extending radially on the side remote of the pockets 6. This has the advantage, among others, that the device 1 can be prepared or provided separately and can be handled and installed in the machine as a unit.

Retainers 11 which prevent the outer twisting rings 2.1; 2.2 from lifting relative to one another in particular, but which allow a relative movement in circumferential direction, are preferably provided. Retainers 11 which engage in an extension of the passages 5, are provided in the depicted exemplary embodiment.

A plurality of notches provided at the outer lateral surfaces of the outer twisting rings 2.1; 2.2 are incorporated as positioning indicators 9 in FIG. 2. Different positions can be marked by a plurality of positioning indicators 9 provided at a defined distance from one another and, aside from an initial position, for example, different twisting angles can also be determined for different variants of coils.

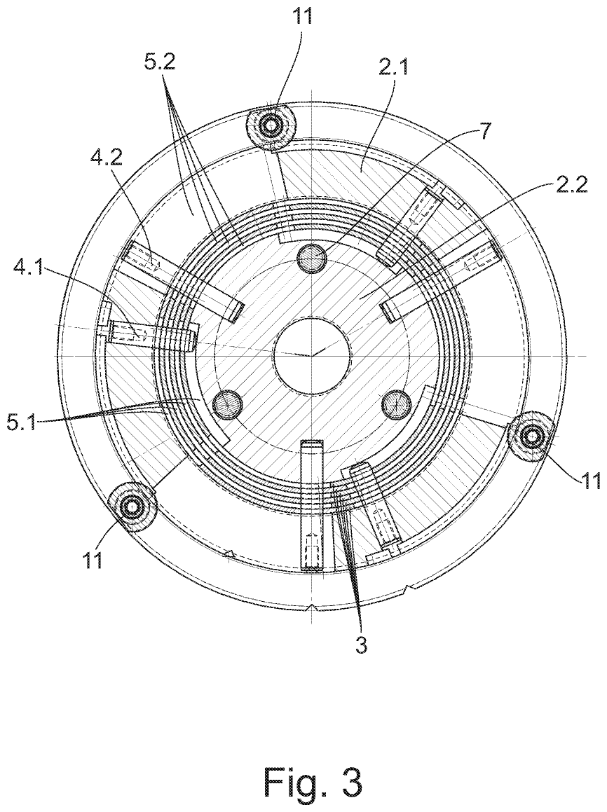

FIG. 3 shows a sectional view of an exemplary embodiment according to FIG. 2, in which the section extends along a plane in the area of the passages 5 which runs perpendicular to the rotational axis.

The outer twisting rings 2.1; 2.2 are solidly constructed. The inside outer twisting ring 2.2 is connected to a drive by fasteners 7, in this case screws. Further, the outer twisting ring 2.2 on the inner side has an area which extends outward in radial direction and at which retainers 11 are provided. The retainers 11 are formed in this exemplary embodiment as washers which are flattened on one side and which, depending on the rotational position, allow a lifting of the outside outer twisting ring 2.1 or engage in a groove of the outer twisting ring 2.1 formed as an extension of the passage 5; 5.2 in order to prevent lifting. The groove can be connected to the passage 5; 5.2 or can also be formed separate therefrom. Also, the groove can have a width and/or depth deviating from that of the passage 5; 5.2 and/or can be provided at another height in axial direction. It is also possible that the groove is formed by the passage 5; 5.2 itself, especially when the passage 5; 5.2 encompasses a circumferential area that is larger than the twisting angle or the couplings 4.2 arranged in the passage 5; 5.2 do not extend over the entire radial length of the outer twisting ring 2.1.

Couplings 4.1; 4.2 are received, respectively, in the outer twisting rings 2.1; 2.2 in order to connect twisting rings 2.1; 2.2; 3 of like rotational direction to one another. Corresponding passages 5.1; 5.2 for the couplings 4.1; 4.2 of the other respective rotational direction are correspondingly provided in the twisting rings 2.1; 2.2; 3. The twisting rings 2.1; 2.2; 3 can be twisted relative to the traversing couplings 4.1; 4.2 through the passages 5.1; 5.2.

In the depicted exemplary embodiment, the couplings 4.1; 4.2 are constructed as alignment pins extending in radial direction. A threaded bore hole is provided at one end in the alignment pins in order to make possible or simplify disassembly of the device.

Three couplings 4.1; 4.2 are arranged for each rotational direction is FIG. 3 so as to be uniformly distributed over the circumference. More couplings 4.1; 4.2 or fewer couplings 4.1; 4.2 can also be provided for each rotational direction depending on the size of the device and the occurring forces. Different quantities of couplings 4.1; 4.2 can also be provided for the different rotational directions.

Couplings 4.1 for a first rotational direction are received in the outside outer twisting ring 2.1 for a first rotational direction. These couplings 4.1 are also connected to every second inner twisting ring 3 so that the latter can be moved in a like rotational direction by a like twisting angle. In the inner twisting rings 3 located therebetween and in the inside outer twisting ring 2.2, corresponding passages 5.1 are provided through which the couplings 4.1 for a first rotational direction can pass and accordingly be moved relative to one another.

Correspondingly, couplings 4.2 for a second rotational direction are received in the inside outer twisting ring 2.2. These couplings 4.2 connect the inside outer twisting ring 2.2 to the corresponding inner twisting rings 3 with like rotational direction. Similarly, the twisting rings 2.1; 3 with a first rotational direction have corresponding passages 5.2 for the couplings 4.2 of the second rotational direction.

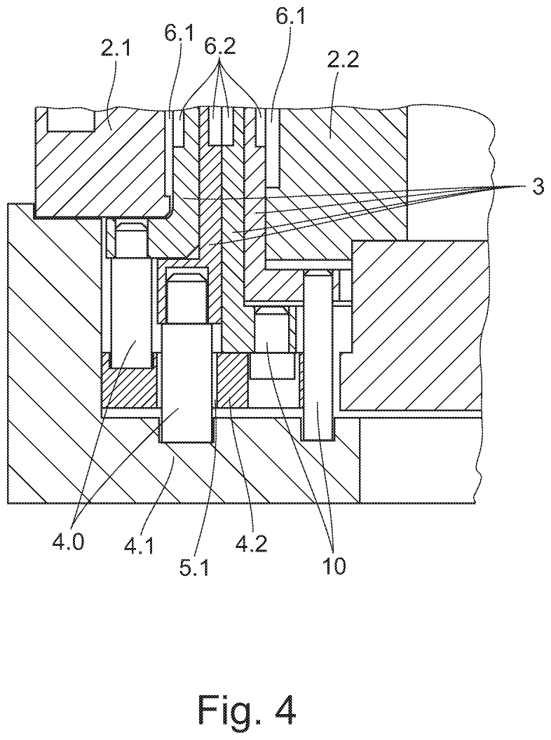

FIG. 4 shows a section along a plane of a further exemplary embodiment extending in radial and axial direction, only one half of which is shown. The twisting rings 2.1; 2.2; 3 are shown in an initial position.

In this exemplary embodiment, four inner twisting rings 3 are provided in addition to the outer twisting rings 2.1; 2.2 and, just as in the other exemplary embodiments, a different quantity of twisting rings may be provided depending on the coil to be produced.

Pockets 6; 6.1; 6.2 for receiving contact ends which are to be shaped are formed in each instance at an axial end of the twisting ring 2.1; 2.2; 3. It is shown that the pockets 6; 6.1; 6.2 in this exemplary embodiment are open in each instance toward a circumferential surface of the twisting rings 2.1; 2.2; 3, and the open circumferential surfaces of directly adjacent twisting rings 2.1; 2.2; 3 face one another in each instance. As a result, the closed circumferential surfaces of the inner twisting rings 3 face a closed circumferential surface of a directly adjacent inner twisting ring 3 in each instance. By means of a configuration of this kind, besides the twisting movement in which they are shaped in circumferential direction, the contact ends can approach one another simultaneously as contact pairs to be connected to one another in a double layer.

With the individual pockets 6; 6.1; 6.2 of a twisting ring 2.1; 2.2; 3, particularly of an inner twisting ring 3, the open circumferential surface and closed circumferential surface can be exchanged varyingly in order to provide contact pairs for a transition between the double layers. Correspondingly, pockets 6.1 for contact ends which are to be connected to an interconnect and therefore not connected to another contact end can be formed without an open circumferential surface or can oppose a closed circumferential surface at the end of the twisting movement.

Particularly the outer twisting rings 2.1; 2.2 can have a quantity of pockets 6; 6.1; 6.2 diverging from the quantity of slots of the coil to be produced, especially in embodiment forms in which more twisting rings are provided in total than layers at the coil.

The inner twisting rings 3 in the pockets 6.2 shown in FIG. 4 have a second depth in axial direction so that at least the—preferably uninsulated—contact ends which are to be deformed and subsequently connected to form contact pairs can be securely received, and an end region of the contact ends which extends in axial direction after deformation is also retained by means of this second axial depth.

Conversely, the outer twisting rings 2.1; 2.2 shown in FIG. 4 have pockets 6.1 which have a first axial depth with a greater extension in axial direction than the pockets 6.2 with a second depth of the inner twisting rings 3. The latter are provided for receiving contact ends which are connected to an interconnect and are not combined to form a contact pair. The larger axial extension of the first axial depth provides room for the contact ends for the interconnect which are generally formed to be longer.

Pockets 6; 6.1; 6.2 with a first axial depth and/or second axial depth can be provided at a twisting ring 2.1; 2.2; 3. The pockets 6.1 with a first axial depth are provided at least at the positions for contact ends which are to be connected to an interconnect. In order to enable the use of like twisting rings 2.1; 2.2; 3 for different coils if required and/or to simplify production and assembly, all of the pockets 6 of a twisting ring 2.1; 2.2; 3 can also be provided with pockets 6.1 of a first axial depth, since individual contact ends which are to be connected to form a contact pair can also be held by the latter for deformation.

The inner twisting rings 3 of the exemplary embodiment shown in FIG. 4 have coaxially nested projections in radial direction on their axial side remote of the pockets 6; 6.1; 6.2 in order to augment the width of this end face in radial direction.

The couplings 4.1; 4.2 are connected to the outer twisting rings 2.1; 2.2 and encompass a portion extending in axial direction, there being provided a sufficient clearance between the couplings 4.1; 4.2 for receiving the nested projections of the inner twisting rings 3 in radial direction.

Adjoining the axial portion of the couplings 4.1; 4.2 in each instance are radially extending portions which overlap at least the radial projections of the inner twisting rings 3 with a like rotational direction. As is shown, the radial portions of the couplings 4.1; 4.2 can be successive along axial direction. In a construction of this kind, at least the couplings 4.1; 4.2 facing the inner twisting rings 3, namely, in FIG. 4, couplings 4.2 for a second rotational direction, have passages 5.1; 5.2 for the couplings 4.1; 4.2 on the side facing away.

The connection between the couplings 4.1; 4.2 and the inner twisting rings 3 is carried out in the depicted exemplary embodiment via connection pins 10. In FIG. 4, the connection pins 10 of the couplings 4.1 for a first rotational direction extend through passages 5.1 in couplings 4.2 for a second rotational direction. Instead of connection pins 10, alignment pins or the like can also be used. Details of the passages 5.1 with respect to circumferential length and the like are analogous to those given for the other exemplary embodiments.

Alternatively, the radially extending portions of the couplings 4.1; 4.2 can extend in a plane when they extend only over partial areas of the circumference and have a sufficient clearance in circumferential direction for the twisting movement. In variants of this kind, a passage 5.1; 5.2 can be omitted and the couplings 4.1; 4.2 can be used directly as a stop for limiting the twisting angle.

The invention is not limited to the described embodiments. As stated above, only individual advantageous features may be provided, or various features of different examples may be combined with one another.

Although exemplary embodiments have been discussed in the above description, it should be noted that numerous modifications are possible. Furthermore, it should be noted that the exemplary embodiments are merely examples which are not intended to limit the scope of protection, the applications and the structure in any way. Rather, a person skilled in the art will take from the above description a guideline for implementation of at least one exemplary embodiment, wherein various modifications may be made, in particular with regard to the function and arrangement of the described components, without departing from the scope of protection as can be gathered from the claims and equivalent feature combinations.

1-14. (canceled)

15. A device (1) for twisting hairpin ends of a coil formed from hairpins for an electric machine, the device comprising:
a plurality of coaxially arranged twisting rings (2.1; 2.2; 3) comprising:
two outer twisting rings (2.1; 2.2) and, therebetween,
at least at least two inner twisting rings (3),
wherein the twisting rings (2.1; 2.2; 3) have, in each instance, at an axial end facing hairpin ends, a plurality of pockets (6; 6.1; 6.2) distributed over a circumference for receiving a hairpin end, respectively, and
wherein the twisting rings (2.1; 2.2; 3) are twistable in opposite directions relative to one another, wherein the twisting rings (2.1; 2.2; 3) have couplings (4.1; 4.2) by which twisting rings (2.1; 2.2; 3) with like rotational direction are connectable.

16. The device (1) according to claim 15, wherein directly adjacent twisting rings (2.1; 2.2; 3) are twistable in opposite directions.

17. The device (1) according to claim 16, wherein at least the inner twisting rings (3) have a passage (5.1; 5.2) for the couplings (4.1; 4.2) of the twisting rings (2.1; 2.2; 3) with a different rotational direction.

18. The device (1) according to claim 17, wherein the passage (5.1; 5.2) is configured as an elongated hole extending over a portion of the circumference.

19. The device (1) according to claim 15, wherein the twisting rings (2.1; 2.2; 3) have in each instance at least two couplings (4.1; 4.2) which are distributed, preferably symmetrically, over the circumference.

20. The device (1) according to claim 15, wherein the couplings (4.1; 4.2) are each configured as an alignment pin receivable in corresponding receptacles at the twisting rings (2.1; 2.2; 3).

21. The device (1) according to claim 20, wherein at least one of the twisting rings (2.1; 2.2; 3) have receptacles which, in a movement direction, have a clearance relative to the alignment pin in the initial position in order to move the twisting ring (2.1; 2.2; 3) by a rotational angle that is smaller than the alignment pin by an amount corresponding to the clearance.

22. The device (1) according to claim 15, wherein the quantity of twisting rings (2.1; 2.2; 3) corresponds to the quantity of layers of the coil.

23. The device (1) according to claim 15, wherein the quantity of pockets (6; 6.1; 6.2) per twisting ring (2.1; 2.2; 3) corresponds to the quantity of slots of the coil.

24. The device (1) according to claim 15, wherein the pockets (6; 6.1; 6.2) are configured to be open on one side in radial direction, wherein the pockets (6; 6.1; 6.2) of the outer twisting rings (2.1; 2.2) are configured in each instance to open in direction of the further twisting rings (2.1; 2.2; 3), and in that the pockets (6; 6.1; 6.2) of the inner twisting rings (3) are configured in each instance to open toward the open side of the pockets (6; 6.1; 6.2) of a directly adjacent twisting ring (2.1; 2.2; 3).

25. The device (1) according to claim 15, wherein the pockets (6; 6.1; 6.2) have at least a depth in axial direction corresponding to an uninsulated length of the hairpin ends.

26. The device (1) according to claim 15, wherein the outer twisting rings (2.1; 2.2) have fasteners (7) by which the device (1) is connectable to drives (8) for the rotational movements.

27. A method for twisting hairpin ends of a coil for an electric machine by the device (1) according to claim 15, the method comprising:
fitting the device (1) on the hairpin ends, wherein at least the uninsulated hairpin ends are received in pockets (6; 6.1; 6.2) of the twisting rings (2.1; 2.2; 3);
rotating the twisting rings (2.1; 2.2; 3) in opposite directions, wherein twisting rings (2.1; 2.2; 3) which are connected to one another via couplings (4.2; 4.2) are rotated in the same direction; and
removing the coil with shaped hairpin ends from the device (1).

28. An electric machine with a coil which is formed from hairpins and which is produced by the method according to claim 27.
